(19) United States
(12) Patent Application Publication
(10) Pub. No.: US 2008/0246248 A1
(43) Pub. Date: Oct. 9, 2008

(54) Hybrid Scooter-Bicycle

(76) Inventors: Samer Rabadi, Burbank, CA (US); Andrew Lucero, Hawthorne, CA (US)

Correspondence Address: PATENT INGENUITY, PC, 520 BROADWAY, SUITE 350, SANTA MONICA, CA, 90401, US

(21) Appl. No.: 11/697,300

(22) Filed: Apr. 6, 2007

(51) Int. Cl. B62K 3/00

(52) U.S. Cl. 280/281.1

(57) ABSTRACT

A hybrid scooter-bicycle is disclosed, comprising a front wheel, a rear wheel, a front fork assembly, and a frame. The front fork assembly comprises a stem and a fork and is operably connected to the front wheel. The front end of the frame comprises a head tube, which is configured to receive the stem of the front fork assembly. The frame further comprises a singular tube extending downward from the head tube to a first intermediate portion of the frame. The frame further comprises a platform for a rider to stand upon. The platform comprises two tubular and substantially parallel frame elements which branch from the singular tube at the first intermediate portion and extend horizontally to a second intermediate portion. The hybrid bicycle scooter also comprises a rear fork, which extends upwardly from the second intermediate portion to the rear end of the frame. The rear fork comprises two substantially parallel prongs to which the rear wheel is operably connected. In one aspect the rear wheel is smaller than the front wheel. The hybrid bicycle scooter also comprises a braking mechanism operably connected with at least one of the front wheel and rear wheels.

### BACKGROUND

1. Field

This disclosure relates generally to vehicles, and more particularly to a hybrid between a scooter and a bicycle.

2. General Background

A kick scooter is a platform with wheels typically propelled by pushing against the ground with the feet. Most are two wheeled vehicles with handlebars for steering the front wheel and a narrow platform near the ground. The user stands on the platform with one foot in front of the other and pushes on the ground with one foot to propel the scooter.

Most scooters are currently configured for children. Furthermore, most scooters tend to have relatively small wheels. Some scooters have wheels that are only a few inches in diameter. In general, such small wheels do not provide much in the way of stability to the scooter. Small wheels can make it difficult to steer and provide little control over the scooter. Such smaller wheels may be adequate and fun for children, but often do not provide enough stability or comfort for adult riders.

### SUMMARY

A hybrid scooter-bicycle is disclosed. The hybrid bicycle-scooter comprises a front wheel, a rear wheel, a front fork assembly, and a frame. The front fork assembly comprises a stem and a fork and is operably connected to the front wheel. The front end of the frame comprises a head tube, which is configured to receive the stem of the front fork assembly. The frame further comprises a singular tube extending downward from the head tube to a first intermediate portion of the frame. The first intermediate portion is located between the front end and rear end of the frame. The frame further comprises a platform for a rider to stand upon. The platform comprises two tubular and substantially parallel frame elements which branch from the singular tube at the first intermediate portion and extend horizontally to a second intermediate portion. The second intermediate portion is located between the first intermediate portion and the rear end. The hybrid scooter-bicycle also comprises a rear fork, which extends upwardly from the second intermediate portion to the rear end of the frame. The rear fork comprises two substantially parallel prongs to which the rear wheel is operably connected. In one aspect the rear wheel is smaller than the front wheel. The hybrid bicycle scooter further comprises a braking mechanism operably connected with at least one of the front wheel and rear wheels.

In another aspect, a frame for a scooter-bicycle is disclosed. The frame comprises a front end and a rear end. The front end comprises a head tube which is configured to receive a front fork assembly for steering a front wheel. The frame also comprises a singular tube extending downward from the front end to a first intermediate portion, the first intermediate portion being located between the front end and the rear end. The frame further comprises a platform for a rider to stand upon. The platform comprises two tubular and substantially parallel frame elements which branch from the singular tube at the first intermediate portion and extend horizontally to a second intermediate portion. The second intermediate portion is located between the first intermediate portion and the rear end. The frame further comprises a rear fork which extends upwardly from the second intermediate portion to the rear end of the frame. The rear fork comprises two substantially parallel prongs operably connected to a rear wheel.

In one aspect the frame is composed of a single tubular construction. In one aspect, the frame is composed of tubular portions welded together to form a continuous piece. In yet another aspect, the head tube, the singular tube, the platform, and the rear fork are connected to form a singular and continuous frame.

The hybrid scooter-bicycle further comprises handlebars operably connected to the stem of the front fork assembly. The braking mechanism is operated by a hand brake, a foot brake, or a combination of both.

In one embodiment, the front wheel measures between 24 and 29 inches in diameter and the rear wheel measures between 16 and 22 inches in diameter. In one embodiment, the diameter of the front wheel is approximately one third the total length of the hybrid scooter-bicycle. Furthermore, in one aspect, the front wheel and rear wheels are traditional bicycle wheels and tires.

### DRAWINGS

The above-mentioned features and objects of the present disclosure will become more apparent with reference to the following description taken in conjunction with the accompanying drawings wherein like reference numerals denote like elements and in which:

FIG. 1 illustrates a frontal perspective view of one embodiment of a hybrid scooter-bicycle in accordance with the present disclosure.

FIG. 2 illustrates a rear perspective view of one embodiment of a hybrid scooter-bicycle in accordance with the present disclosure.

FIG. 3 illustrates a side view of one embodiment of a hybrid scooter-bicycle in accordance with the present disclosure.

FIG. 4 illustrates a perspective view of one embodiment of the frame for a hybrid scooter-bicycle in accordance with the present.

### DETAILED DESCRIPTION

A vehicle is disclosed, which combines elements from a conventional bicycle with a scooter, and is therefore considered a hybrid scooter-bicycle. For example, in one aspect the hybrid scooter-bicycle of the present disclosure has conventional bicycle tires, both in terms of size and style. The hybrid scooter-bicycle of the present disclosure is also similar in size to a conventional bicycle, and therefore larger than most conventional scooters. Bicycles tend to have much larger wheels than scooters, which provide greater stability, ease of control and maneuverability. In many aspects, the hybrid scooter-bicycle in accordance with the present disclosure has the overall look and feel of a bicycle, except that is has no seat to sit upon, and no pedals to propel it to move. The utilization of features from a bicycle allow the hybrid scooter-bicycle to be operated by both children and adults.

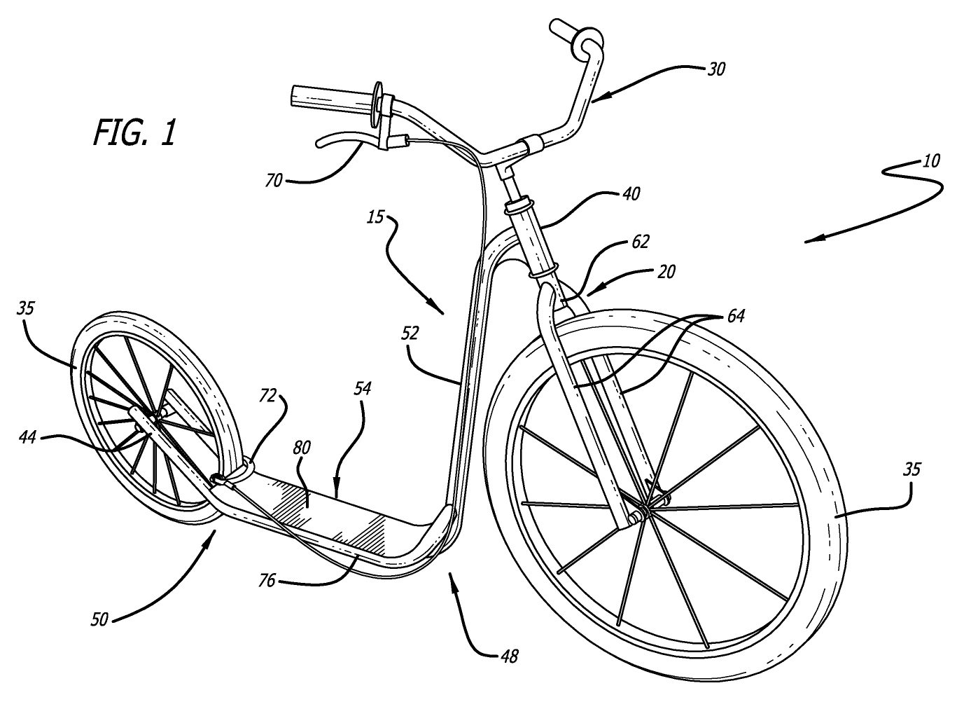

A hybrid scooter-bicycle in accordance with the present disclosure is now described with reference to FIGS. 1-4. FIG. 1 illustrates a frontal perspective view of a hybrid-scooter bicycle in accordance with the present disclosure. The hybrid scooter-bicycle 10 includes a contoured frame 15. The frame is coupled at one end to a front fork assembly 20, which is in turn connected to a front wheel 25 and handlebars 30. The other end of the frame 15 is coupled to a rear wheel 35. In one embodiment, the frame 15 comprises a tubular structure. A tubular structure provides strength, while maintaining the overall weight of the frame. The frame 15 is defined as the structure extending from a front end 42 which forms the head tube 40 to a rear end 46 which forms the rear fork 44.

In one aspect, the frame 15 comprises a singular and continuous tubular structure. By singular and continuous, it is intended that the finished or manufactured frame comprise a single piece of material, or be manufactured of more than one piece that are welded or semi-permanently fastened together to yield a single piece. In other words, the finished frame 15 is not constructed of multiple pieces that can be easily separated. For example, there are no hardware type fasteners which connect portions of the frame together, such as screws, bolts, pins, rivets, etc.

Therefore, the frame 15 may be manufactured from a single piece of metal that is shaped or blown to form the finished contoured frame. Alternatively, the frame may be constructed of more than one piece of metal. However the pieces are permanently fastened or welded together such that the final frame appears as a singular and continuous piece.

In one embodiment, the frame 15 is manufactured from one and one quarter inch steel tubing. It is foreseen that the frame 15 may be constructed of many other materials and/or thicknesses, provided the material has properties sufficient to provide the required strength and rigidity for the structure.

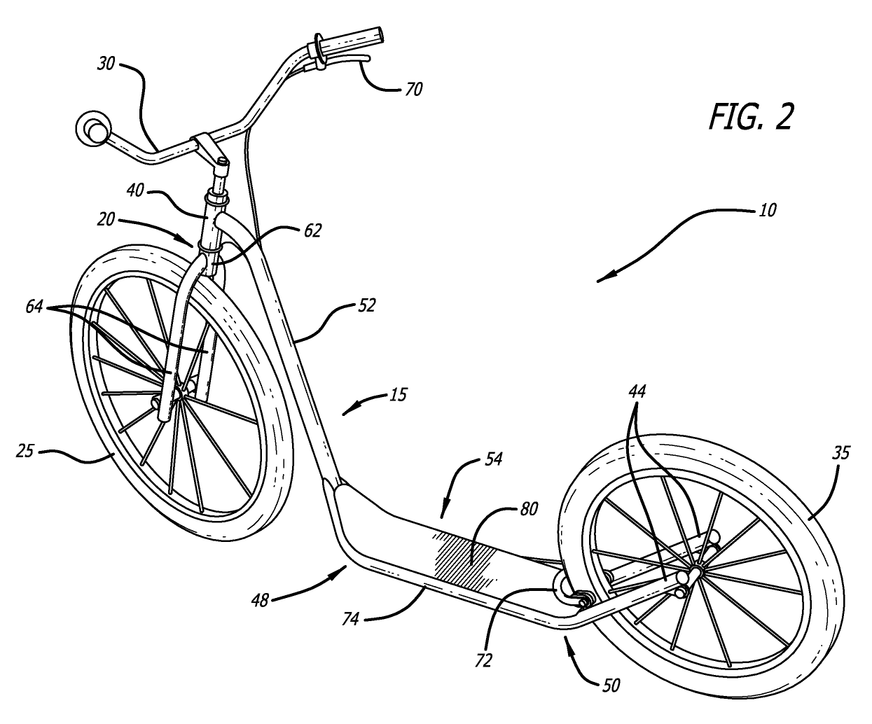

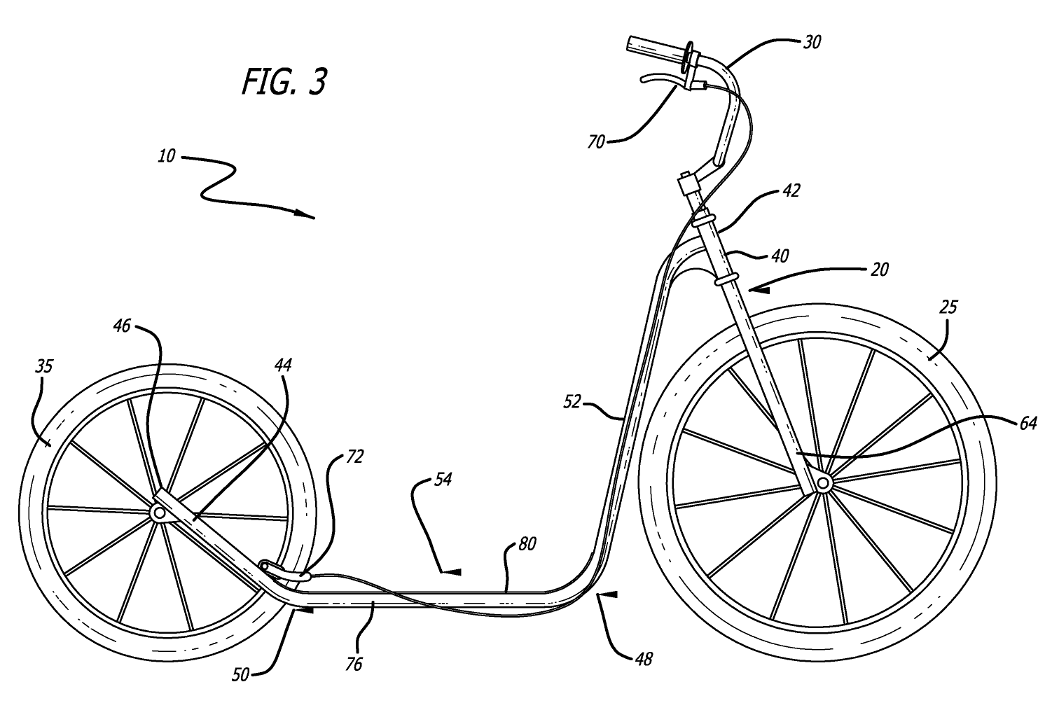

FIG. 2 illustrates a rear perspective view of the hybrid scooter-bicycle illustrated in FIG. 3. Accordingly, the rear perspective view also shows a configuration that allows for ease of use by both children and adults.

FIG. 3 illustrates a side view of one embodiment of a hybrid scooter-bicycle in accordance with the present disclosure. As mentioned above, the frame 15 is defined by a front end 42 and a rear end 46. The front end is defined by the head tube 40. The head tube 40 refers to the short, substantially vertical tube which receives the steering column and facilitates movement of the front wheel by allowing the steering column to rotate within. The steering column is often not visible, being concealed inside the head tube.

The rear end 46 of the frame terminates at the rear fork 44, which connects to the rear wheel 35. The fork refers to the two substantially parallel prongs that hold the axis of the wheel.

For ease of description, the frame 15 will also be described as having a first intermediate portion 48 and second intermediate portion 50 located in between the front end 42 and rear end 46.

The frame extends downwardly from the front end 42 to a first intermediate location 48 to define a single down tube 52. This is often referred to as a monotube construction in bicycles. In an exemplary embodiment, the down tube 52 extends at an angle of approximately seventy five to eighty degrees from horizontal.

It should be noted that in the embodiment shown in the figures, there is only a singular down tube 52. In other words there are no structural elements, braces, or supports in addition to the single down tube in the region extending from the front end 42 to the first intermediate portion 48 of the frame.

It is common for current scooters to have more than one down tube extending from the head tube or general region of the handlebars to the platform where the rider stands. Alternatively it is common for current scooters to have some sort of cross brace or support which extends from the down tube portion of the scooter to some other portion of the scooter or frame which provides additional support. Therefore, the design of the frame not only differs from current scooters, but is furthermore aesthetically pleasing in its grace and simplicity.

The frame 15 then extends horizontally from the first intermediate location 48 to the second intermediate location 50, providing the structure for a platform 54 for a rider to stand on.

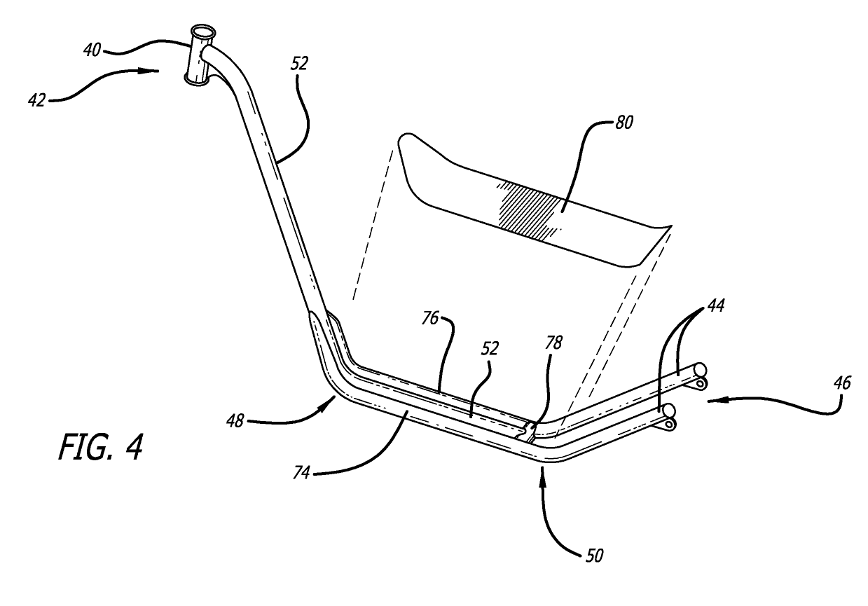

FIG. 4 illustrates a perspective view of one embodiment of the frame for a scooter in accordance with the present. As can be seen in FIG. 4, the platform portion 54 of the frame is illustrated in more detail. In one aspect, the frame 15 branches out at the first intermediate location 48 to form at least two substantially parallel tubes which extend the length of the platform 54. In another embodiment, the frame structure below the platform comprises three spaced tubes. The single down tube 52 extends beyond the first intermediate portion horizontally to the second intermediate portion. In addition, a branching of the frame 15 occurs at the first intermediate portion 48 to form two parallel tubes, i.e., a first parallel tube 74 and a second parallel tube, 76 which extend horizontally from the first intermediate portion 48 to the second intermediate portion 50. The two parallel tubes are substantially parallel and, along with the center tube form flat horizontal surface for the platform to stand upon.

There may also be a cross tube 78 located at the second intermediate portion for added strength. In one aspect, there may be a plurality of tubes perpendicularly spaced between the parallel tubes from the first to the second intermediate locations to provide greater reinforcement for the platform.

In one embodiment, the platform is completed by a rigid plate 80 coupled to the top of the parallel tubes to provide increased comfort and stability for the user to stand upon. The rigid plate 80 may be further covered by material such as rubber, or another non-skid surface. In another embodiment, the platform upon which a rider stands is located approximately four inches from the ground, and the area for standing measures approximately eighteen inches in length by six inches in width.

The frame 15 extends upwardly from the second intermediate location 52 to the rear end 42 to define a rear fork 44 having two spaced prongs, through which the rear wheel 30 is located. In one aspect, the rear fork 44 extends upward from the second intermediate location 52 at an angle of approximately forty to forty-five degrees from the horizontal. This angle may of course vary, depending on the size of the wheel used.

In an exemplary embodiment, the frame 15 of the hybrid scooter-bicycle is approximately four feet in length.

As mentioned above, the front end of the frame is connected to a front fork assembly 20. The front fork assembly is the portion of a bicycle or scooter that holds the front wheel and allows one to steer. The front fork assembly 20 includes a stem 62 and two spaced prongs 64 extending downwardly therefrom. In one embodiment, the front fork 20 is oriented downward at an angle of approximately twenty-five to thirty degrees from the vertical. The stem 62 is disposed within the steering column. The front fork 60 may be similar to the fork used on conventional bicycles. The stem of the fork interfaces with the head tube of the frame via a set of bearings known as a headset.

Handlebars 30 are coupled to the upper end of the head tube so that the front fork 20 can be directionally pivoted by the operator in relation to the frame 15. The handlebars 30 are similar to those used on conventional bicycles.

A front wheel 25 is mounted between the prongs 64 of the front fork 20 for rotation. The ratio of front wheel diameter to total vehicle length is between one half to one third. A rear wheel 35 is mounted between the prongs of the rear fork 44 for rotation. The ratio of rear wheel diameter to total vehicle length is between about one third to one quarter. In the exemplary embodiment, the wheels used are standard spoked bicycle wheels, the front wheel measuring twenty-six inches in diameter, and the rear wheel measuring twenty inches in diameter. Of course, other sized wheels may be used. For example, the front wheel and tire may range from twenty-four to twenty-nine inches in diameter. The rear wheel and tire may range from sixteen to twenty-two inches in diameter. The use of conventional bicycle wheels ensures ease of replacement and repair. Fenders can be coupled to the frame and placed over the wheels to shield a user from road debris. The hybrid scooter-bicycle has large wheels, and in one aspect, the front wheel is larger than the rear wheel.

The hybrid scooter-bicycle further may have a braking mechanism. The brake may be coupled to either the front or rear wheel. In one aspect, the braking mechanism is affected through a handbrake 70 coupled to the handlebars. The handbrake is similar to those used on conventional bicycles. In the preferred embodiment, the handbrake is a standard bicycle handbrake.

In another embodiment, a foot brake is coupled to the platform so that a rider can operate the brake by depressing a foot to decrease the speed of the hybrid scooter-bicycle. In yet another embodiment, a combination of a hand brake and a foot brake may be incorporated. In yet another embodiment, two handbrakes can also be used to apply a braking force to the front wheel and/or the back wheel.

In one embodiment, the hybrid scooter-bicycle has a kickstand which allows the hybrid bicycle-scooter to stand on its own. In another embodiment, the hybrid bicycle-scooter in accordance with the present disclosure may be adapted to operate with a motor.

In yet another embodiment, the hybrid scooter-bicycle is designed primarily for adults, or riders approximately four feet or taller, and weighing over one hundred pounds. The overall length of the adult sized hybrid scooter-bicycle in an exemplary embodiment is about 68 inches.

Although the hybrid scooter-bicycle in accordance with the present disclosure was designed with an adult in mind, it is foreseen that the hybrid bicycle-scooter may be easily adapted to fit younger riders such as children. In such a case, the hybrid scooter-bicycle would likely be scaled down in size. The frame would be smaller such that the handlebars are positioned at the correct height for a child, and the wheel would be scaled accordingly. For example, the front wheel of a child's version of the hybrid scooter-bicycle may range from sixteen to twenty inches in diameter, while the rear wheel ranges from twelve to sixteen inches.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A hybrid scooter-bicycle comprising:
a front wheel;
a front fork assembly comprising a stem, and a fork operably connected to the front wheel;
a head tube located at a front end of a tubular frame, the head tube configured to receive the stem of the front fork assembly;
a singular tube extending downward from the head tube to a first intermediate portion of the frame, the first intermediate portion being located between the front end and a rear end of the frame;
a platform for a rider to stand upon, the platform comprising two tubular and substantially parallel frame elements which branch from the singular tube at the first intermediate portion and extend horizontally to a second intermediate portion, the second intermediate portion being located between the first intermediate portion and the rear end, and
a rear fork, the rear fork extending upwardly from the second intermediate portion to the rear end of the frame, the rear fork comprising two substantially parallel prongs;
a rear wheel operably connected to the rear fork at the rear end of the frame, the rear wheel being smaller than the front wheel; and
a braking mechanism operably connected with at least one of the front wheel and rear wheel.

2. The hybrid scooter-bicycle of claim 1 wherein the frame is composed of a single tubular construction.

3. The hybrid scooter-bicycle of claim 1 wherein the frame is composed of tubular portions welded together to form a continuous piece.

4. The hybrid scooter-bicycle of claim 1 wherein the platform is covered by a plate.

5. The hybrid scooter-bicycle of claim 1 further comprising handlebars operably connected to the stem of the front fork assembly.

6. The hybrid scooter-bicycle of claim 1 wherein the braking mechanism is operated by a hand brake.

7. The hybrid scooter-bicycle of claim 1 wherein the braking mechanism is operated by a foot pedal.

8. The hybrid scooter-bicycle of claim 1 wherein the front wheel measures between 24 and 29 inches in diameter.

9. The hybrid scooter-bicycle of claim 1 wherein the rear wheel measures between 16 and 22 inches in diameter.

10. The hybrid scooter-bicycle of claim 1 wherein the diameter of the front wheel is approximately one third the total length of the hybrid scooter-bicycle.

11. The hybrid scooter-bicycle of claim 1 wherein the front wheel and rear wheel are traditional bicycle tires.

12. A frame, comprising:
a front end and a rear end, the front end comprising a head tube, the head tube configured to receive a front fork assembly for steering a front wheel;
a singular tube extending downward from the front end to a first intermediate portion, the first intermediate portion being located between the front end and the rear end;
a platform that includes two tubular and substantially parallel frame elements which branch from the singular tube at the first intermediate portion and extend horizontally to a second intermediate portion, the second intermediate portion being located between the first intermediate portion and the rear end, and
a rear fork, the rear fork extending upwardly from the second intermediate portion to the rear end, the rear fork comprising two substantially parallel prongs operably connected to a rear wheel.

13. The frame of claim 12 wherein the frame is made of tubular steel.

14. The frame of claim 12 wherein the frame is a singular and continuous piece of material.

15. The frame of claim 12 wherein the frame is composed of tubular portions welded together to form a continuous piece.

16. The frame of claim 12 wherein the platform is covered by a substantially flat plate.

17. The frame of claim 12 wherein there are no members beyond the singular tube in the region extending from the front end to the first intermediate portion which provide support to the frame.

18. The frame of claim 12 wherein the singular tube extends downward at an angle between 75 to 80 degrees from the horizontal.

19. A hybrid scooter-bicycle comprising:
a front wheel;
a front fork assembly comprising a stem on an upper end, and a fork on a lower end, the fork operably connected to an axis of the front wheel;
a head tube located at a front end of a tubular frame, the head tube comprising a substantially vertical tube configured to receive the stem of the front fork assembly, the stem when rotated within the head tube causes steering of the front wheel;
a singular tube extending downward from the head tube to a first intermediate portion of the frame, the first intermediate portion being located between the front end and a rear end of the frame;
a platform that includes two tubular and substantially parallel frame elements which branch from the singular tube at the first intermediate portion and extend horizontally to a second intermediate portion, the second intermediate portion being located between the first intermediate portion and the rear end, the platform further covered with a plate for a rider to stand on; and
a rear fork, the rear fork extending upwardly from the second intermediate portion to the rear end of the frame, the rear fork comprising two substantially parallel prongs;
a rear wheel operably connected to the rear fork at the rear end of the frame, the rear wheel being smaller than the front wheel; and
a braking mechanism operably connected with at least one of the front wheel and rear wheel.

20. The hybrid scooter-bicycle of claim 19 wherein the head tube, the singular tube, the platform, and the rear fork are connected to form a singular and continuous frame.
